(19) United States
(12) Patent Application Publication
(10) Pub. No.: US 2022/0194439 A1
(43) Pub. Date: Jun. 23, 2022

(54) CHASSIS FOR A RAIL-BOUND TRANSPORT VEHICLE

(71) Applicant: Faigle Kunststoffe GmbH, Hard (AT)

(72) Inventor: Tobias KIENREICH, Hörbranz (AT)

(73) Assignee: Faigle Kunststoffe GmbH, Hard (AT)

(21) Appl. No.: 17/557,202

(22) Filed: Dec. 21, 2021

(30) Foreign Application Priority Data
Dec. 21, 2020 (AT) A280/2020

(51) Int. Cl. B61F 5/38; B61D 3/00

(52) U.S. Cl. CPC B61F 5/38; B61D 3/00

(57) ABSTRACT

A chassis (1) for a rail-bound transport vehicle for transporting goods, in particular in intralogistics. The chassis (1) has at least one chassis axle (2) and at least one load-bearing roller (3) configured for rolling on a rail (4) that is rotatably supported on a pivot arm (5) about a roller rotation axis (6) and the pivot arm (5) together with the roller (3) is pivotably supported by a pivot joint (7) on the chassis axle (2). The pivot arm (5) is additionally supported by a support bearing (8) on the chassis axle (2) and the roller (3) is arranged between the pivot joint (7) and the support bearing (8).

### INCORPORATION BY REFERENCE

The following documents are incorporated herein by reference as if fully set forth: Austrian Patent Application No. 280/2020, filed Dec. 21, 2020.

### TECHNICAL FIELD

The present invention relates to a chassis for a rail-bound transport vehicle for transporting goods, in particular in intralogistics, wherein the chassis has at least one chassis axle and at least one load-bearing roller, wherein the roller for rolling on a rail is rotatably supported in a pivot arm about a roller rotation axis and the pivot arm together with the roller is pivotably supported by means of a pivot joint on the chassis axle.

### BACKGROUND

In particular in intralogistics, that is to say, during goods transport within a warehouse or a business premises, in the prior art rail-bound transport vehicles which travel with a corresponding chassis on a rail system are used in order to thus transport goods from one location to another location within a business premises and in particular within a warehouse. In this instance, the chassis must in principle also be suitable for traveling along bends in the rail system.

WO 2016/068705 A1 discloses a generic chassis in which the rollers of the chassis which roll on the tracks are rotatably supported, on the one hand, in a pivot arm about the roller rotation axes thereof and the pivot arm, on the other hand, together with the roller is pivotably supported on the vehicle axle by means of a pivot joint.

The chassis for such rail-bound transport vehicles generally have to be constructed to be relatively flat over the rails. Particularly when the transport vehicles are driven in an inductive manner, relatively tight tolerances have to be taken into account. In the prior art, for this reason the pivot joints have to be constructed from relatively expensive angular ball bearings so that the loads which arise as a result of the transport vehicle and the goods which are transported therein can be transmitted via the pivot joint to the roller and consequently to the rail.

### SUMMARY

An object is to improve a generic chassis in such a manner that the relatively expensive angular ball bearings in the pivot joint can be dispensed with.

To this end, the invention provides that the pivot arm be additionally supported by means of a support bearing on the chassis axle and the roller be arranged between the pivot joint and the support bearing.

A basic notion of the invention is consequently to transmit the load which occurs as a result of the transport vehicle and the goods which are transported therein to the rollers not only via the pivot joint but also additionally via a support bearing, wherein the roller is arranged between the pivot joint and the support bearing. The pivot joint itself is thereby substantially relieved. In the pivot joint, it is possible to dispense with the relatively expensive angular ball bearings which are required in the prior art since a portion of the load is transmitted precisely via the additionally provided support bearing.

The chassis according to the invention may have an individual chassis axle, but also a plurality of chassis axles which are connected to each other by means of the transport vehicle itself or a corresponding longitudinal carrier. The chassis axles could also be referred to as support axles or supports. They are advantageously elongate per se. The transport vehicle is arranged on the chassis in a manner known per se. In preferred embodiments, on the chassis axle two pivot arms each having a roller are pivotably supported by means of a pivot joint in each case. Each roller is preferably rotatably supported for rolling on one of the rails in the respective pivot arm about a roller rotation axis. According to the invention each pivot arm is advantageously additionally supported by means of a support bearing on the vehicle axle. Preferably, the pivot arms together with the rollers are arranged at mutually opposing ends of the chassis axle. Advantageously, there is provision for a pivot axis of the pivot joint, about which axis the pivot arm can be pivoted, to be arranged parallel with a support direction, wherein the pivot arm is supported on the chassis axle by means of the support bearing in the support direction. Both the pivot axis and the support direction are advantageously arranged during operation of the chassis to be normal with respect to a respective surface of the rails on which the rollers travel in each case. The support bearing is preferably a plain bearing, which permits a pivoting of the pivot arm by means of the pivot joint. It is advantageous in this instance for the plain bearing to have two sliding surfaces which slide along each other when the pivot arm is pivoted. The plain bearing can thus, on the one hand, effectively transmit the forces which occur as a result of the load. On the other hand, it permits pivoting of the pivot arm together with the roller with as little friction as possible so that the chassis or the transport vehicle can also travel around bends of the rail system with as little friction as possible.

The friction coefficients in the plain bearing or between the sliding surfaces are, with respect to the static friction, preferably in the range from 0.05 to 0.45. In order to achieve these very low friction coefficients, preferred variants make provision for one of the sliding surfaces to have metal, preferably steel, or to comprise metal, preferably steel, and for the other of the sliding surfaces to have plastics material or to comprise plastics material. In this instance, for example, polyamides, polyoxymethylene (POM), polyphenylene sulphide (PPS), polyethylene terephthalate (PET), polybutylene terephthalate (PBT), polyolefins, in particular High Density Polyethylene (HD-PE) or Ultra High Molecular Weight Polyethylene (UHMW-PE), polyketone or polyetheretherketone (PEEK) may be considered as plastics materials. In a particularly preferred manner, the plain bearing has an incorporated lubrication. For example, fluoropolymers, polyolefins or silicones can be used as incorporated lubricants in the plain bearing.

The sliding surfaces are advantageously at least in regions, preferably completely constructed in a planar manner. A surface normal on the planar region of one of the sliding surfaces is advantageously arranged parallel with the pivot axis of the pivot joint, about which axis the pivot arm can be pivoted. Preferably, this applies to both sliding faces.

Advantageously, in chassis according to the invention, there is provision for the roller rotation axis to be arranged orthogonally relative to the pivot axis of the pivot joint, about which axis the pivot arm can be pivoted.

Preferred variants of the invention make provision for the chassis to additionally have at least one guide roller which is arranged on the chassis axle and which is resiliently pretensioned by means of a pretensioning apparatus in the direction toward the rail. The guide rollers ensure that the chassis with the rollers thereof is always guided in an optimum manner along the rails.

The roller rotation axis of a respective roller is advantageously located orthogonally with respect to the guide roller rotation axis of a corresponding guide roller. In a particularly preferred manner, there is also provision for a running face of the roller which faces the rail to be arranged orthogonally with respect to a corresponding running face of the guide roller which faces the rail. In preferred variants, a helical spring which pretensions the guide roller in the direction toward the rail is provided as a pretensioning apparatus. Advantageously, the guide roller is pretensioned in a linear manner by the pretensioning apparatus in a direction normal relative to the rail. The resilient force applied by the pretensioning apparatus is advantageously in the range between 0 and 1000 Newton.

In order to achieve the best possible smooth running, there is provision for a vibration damper to be integrated in the pretensioning apparatus. In this instance, for example, this may be a pneumatic damper. In a particularly preferred manner, a spring, in particular a helical spring, of the pretensioning apparatus is arranged within the damper housing of the vibration damper. In order to carry out the damping function, the damper housing may be connected to the environment by means of at least one throttle opening. The air which is pressed through the throttle opening then produces the desired damping effect. Particularly preferred variants make provision for the pretensioning apparatus to be able to be secured to and removed from the chassis axle, preferably without any tools.

Whilst, in the prior art, the chassis axles are generally made from metal, preferred variants of the invention make provision for the vehicle axle to at least for the most part comprise a plastics material. In a particularly preferred manner, this is in this instance a fiber-reinforced plastics material. Suitable plastics materials for this are, for example, polyamides, polypropylene (PP), polyethylene terephthalate (PET), polybutylene terephthalate (PBT), polyoxymethylene (POM), polyphenylene sulphide (PPS) or polyetheretherketone (PEEK). The modulus of elasticity of the chassis axle is advantageously in the range between 2000 MPa (MegaPascal) and 40,000 MPa. It is possible to use, for example, glass fibers, carbon fibers, aramid fibers and/or also basalt fibers, as fibers in fiber-reinforced plastics materials.

As a result of the additional support bearing which is used according to the invention, the pivot joint by means of which the pivot arm is pivotably supported on the chassis axle may be configured in a relatively simple manner. For example, in order to enable the pivoting movement, it may have a simple plain pivot bearing. Also in this instance, there is advantageously provision for one of the sliding surfaces of this plain pivot bearing to have metal, preferably steel, or to comprise metal, preferably steel, and for the other of the sliding surfaces of this plain pivot bearing to have plastics material or to comprise plastics material. In this instance, the plastics materials already mentioned above with respect to the plain bearing and/or incorporated lubricants can also advantageously be used.

### BRIEF DESCRIPTION OF THE DRAWINGS

Other features and details of preferred embodiments of the invention will be explained below by way of example with reference to a construction variant of the invention. In the drawings:

FIG. 1 is a perspective view of a chassis axle according to the invention on two rails;

FIG. 2 is a front view of this;

FIG. 3 is a longitudinal section through the chassis axle of FIG. 2;

FIG. 4 is an enlarged view of the region A from FIG. 3;

FIG. 5 is a front view of the chassis axle together with the pivot arm and roller;

FIG. 6 is a section relating to FIG. 5, and

FIGS. 7 to 10 are illustrations of preferred embodiments of a guide roller on such a chassis axle.

### DETAILED DESCRIPTION

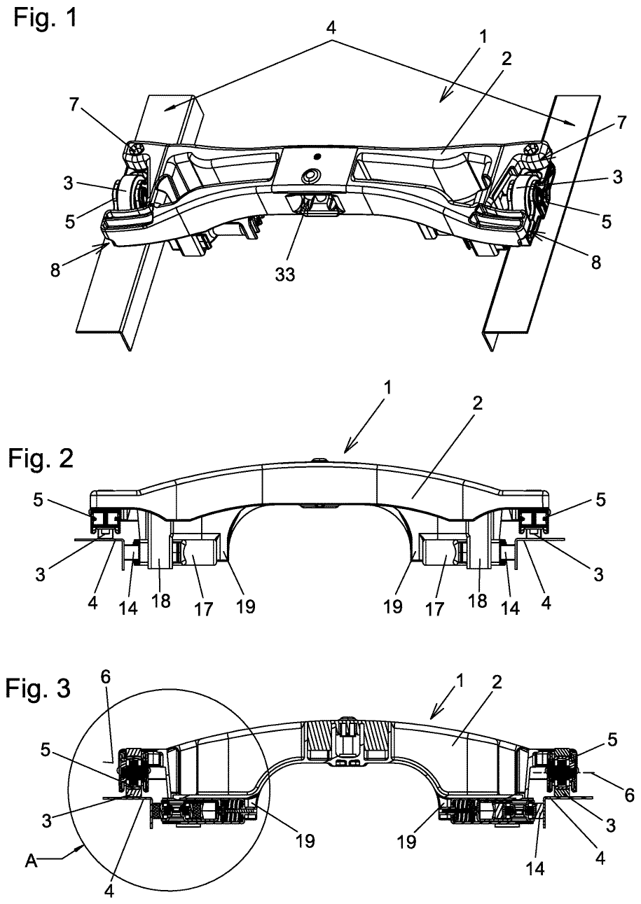

FIG. 1 shows a chassis axle 2 of a chassis 1 according to the invention, which axle 2 can travel with the rollers 3 thereof along two rails 4. The chassis 1 may comprise a single such chassis axle 2. Via the connection 33, however, for example, by means of at least one longitudinal carrier or the like, a plurality of such chassis axles 2 can also be connected to each other to form a chassis 1. On the chassis 1, a corresponding transport vehicle for transporting goods, in particular in intralogistics, is secured. In the prior art, the transport vehicle is known per se in extremely varied embodiments and is not illustrated here. Chassis (1) according to the invention may be formed in extremely varied embodiments. The chassis axle(s) 2 may also be integrated directly in a base of the transport vehicle or the like.

In the embodiment shown, the chassis 1 has two load-bearing rollers 3. The rollers 3 are rotatably supported for rolling on one of the rails 4 in each case in a pivot arm 5 about a roller rotation axis 6. The pivot arms 5 are in each case together with the rollers 3 pivotably supported on the chassis axle 2 by means of a pivot joint 7. According to the invention, there is provision for the pivot arms 5 to be additionally supported on the chassis axle 2 in each case by means of a support bearing 8 and for the rollers 3 to be arranged between the pivot joint 7 and the support bearing 8. FIG. 2 is a front view of the chassis axle 2, FIG. 3 is a longitudinal section through this chassis axle 2.

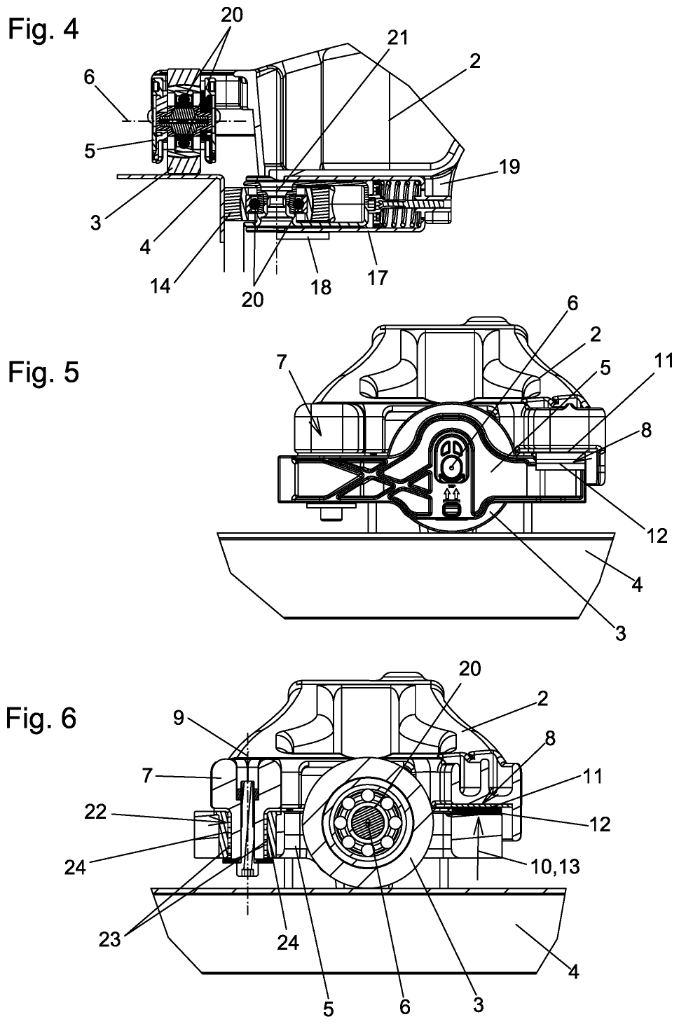

In this embodiment, the chassis 1 additionally has guide rollers 14 which are arranged on the chassis axle 2 and which are resiliently pretensioned by means of a pretensioning apparatus 15, which will be explained in detail below, in the direction toward the respective rail 4 with which they are in abutment. FIG. 4 is an enlarged view of the region A from FIG. 3. In this sectioned illustration according to FIG. 4, it can first clearly be seen that in this embodiment the roller 3 is rotatably supported by means of a ball bearing 20 about the roller rotation axis 6 thereof on the pivot arm 5. The guide roller 14 is also rotatably supported by means of a ball bearing 20 about the guide roller rotation axis 21 thereof. The ball bearings 20 can naturally also be replaced by other suitable bearings. The roller rotation axis 6 and the guide roller rotation axis 21 are, as shown here, preferably located orthogonally with respect to each other. The same also preferably applies to the running surfaces of the roller 3, on the one hand, and the guide roller 14, on the other hand. In cross section, as shown here, the rails 4 are advantageously constructed accordingly so as to be bent at right-angles.

The construction of the chassis 1 according to the invention can be seen particularly clearly in the front view according to FIG. 5 and in the sectioned view which is arranged parallel therewith in FIG. 6. Here, it can be clearly seen that the pivot arm 5 is pivotably supported, on the one hand, by means of the pivot joint 7 on the chassis axle 2, and, on the other hand, in addition by means of a support bearing 8 on the chassis axle 2, wherein the roller 3 is arranged between the pivot joint 7 and the support bearing 8. The loads acting on the chassis 1 or the chassis axle 2 are thereby transmitted symmetrically at both sides of the roller into the pivot arm 5 so that in the pivot joint 7 costly angular ball bearings which are otherwise necessary in the prior art can be dispensed with. The pivot axis 9 of the pivot joint 7, about which axis the pivot arm 5 can be pivoted, extends in this preferred embodiment parallel with the support direction 10. In this support direction 10, the pivot arm 5 is supported on the chassis axle 2 by means of the support bearing 8.

In preferred embodiments, such as the one shown here, the support bearing 8 is configured as a plain bearing. It permits pivoting of the pivot arm 5 by means of the pivot joint 7. The plain bearing has two sliding surfaces 11 and 12 which slide along each other when the pivot arm 5 is pivoted about the pivot axis 9. In order to achieve the lowest possible friction coefficients, preferred variants, such as the one shown here, make provision for one of the sliding surfaces, in this instance the sliding surface 11 on the chassis axle 2, to be made from metal, in particular from steel. The other of the sliding surfaces, in this instance the sliding surface 12 on the pivot arm 5, is advantageously made from a plastics material. Suitable plastics materials were mentioned in the introduction. The friction coefficient is advantageously in the value range mentioned in the introduction. In the embodiment shown, both sliding surfaces 11 and 12 are configured in a planar manner. The surface normal 13 on the planar regions of the sliding faces 11 and 12 extends parallel with the pivot axis 9 of the pivot joint 7. In contrast, the roller rotation axis 6 extends orthogonally to the pivot axis 9.

As a result of the invention, the pivot joint 7 can also be constructed in a relatively simple manner. In the embodiment shown, it has a plain pivot bearing 22 in which two surfaces 23 and 24 slide on each other in order to permit the pivot movement. One of the surfaces, in this instance the surface 23, is advantageously again constructed from metal, in particular steel, the other of the surfaces, in this instance the surface 24, again advantageously comprises plastics material. Both in the surfaces 23 and 24 of this plain pivot bearing 22 and in the sliding surfaces 11 and 12 of the support bearing 8, lubrications are advantageously incorporated. How these may be specifically configured has already been explained in the introduction.

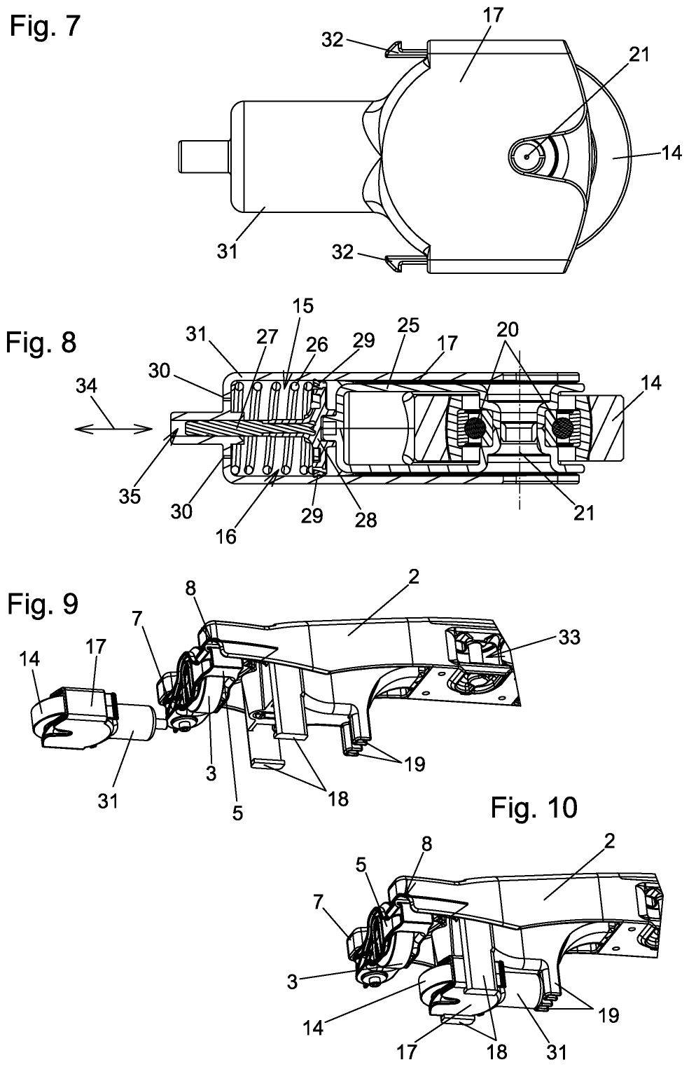

FIGS. 7 to 10 show a preferred embodiment of a guide roller 14 which is used in this embodiment and which is pressed by means of a pretensioning apparatus 15 against the rail. In addition, this pretensioning apparatus 15 also has a vibration damper 16. FIG. 7 is an external view of the housing 17 or pressure piece in which the guide roller 14 which can be rotated about the guide roller rotation axis 21 thereof is supported so as to be able to be linearly displaced. The longitudinal section according to FIG. 8 clearly shows that the guide roller 14 with the ball bearing 20 thereof is rotatably supported in a roller carrier 25. This roller carrier 25 is supported together with the guide roller 14 so as to be able to be displaced in the longitudinal direction 34 in the housing 17. In this instance, the pretensioning apparatus 15 has a helical pretensioning spring 26 which pretensions the plate 28 in the direction away from the throttle openings 30. The roller carrier 25 and consequently the guide roller 14 are supported on this plate 28 and consequently on the pretensioning spring 26 of the pretensioning apparatus 15. In order to guide the plate 28, there is arranged thereon at the side facing away from the guide roller 14 a damping piston 27 which is supported in a guide channel 35 of the damper housing 31 so as to be able to be displaced in the longitudinal direction 34. The damper housing 31 is configured in this instance as a part-region of the housing 17, but naturally this does not absolutely have to be the case. In the embodiment shown here, the plate 28 is in any case sealed with respect to the damper housing 31 by means of the seal 29. At the side of the plate 28 facing away from the guide roller 14, there is thus formed in the damper housing 31 a pressure chamber which is connected to the environment only by means of the throttle openings 30. This part-volume between the plate 28 and the throttle openings 30 within the damper housing 31 forms in this embodiment a pneumatic vibration damper 16. The opening cross sections of the throttle openings 30 can be selected in such a manner that the desired damping effect is achieved. The damping effect is produced in this instance when pressing together and consequently when reducing the part-volume between the plate 28 and throttle openings 30 by air being able to escape outward through the throttle openings 30 only in a braked manner. Conversely, the throttle openings 30 also have a throttling action when air enters the part-volume between the plate 28 and throttle opening 30 from the outer side so that the desired damping effect is also achieved in this direction. The integration of the pretensioning apparatus 15 and vibration damper 16 is consequently produced in this embodiment as a result of the fact that, on the one hand, the pretensioning spring 26 is arranged in the interior of the damper housing 31 and, on the other hand, the vibration damper 16 described is also restrictedly coupled to the pretensioning apparatus 15.

The delimiting projections 32 which can be seen in FIG. 7 serve only to displaceably secure the roller carrier 25 in the housing 17.

It should further be noted that the variant of the pretensioning apparatus 15 as shown here by way of example acts in a linear manner in a longitudinal direction 34 on the guide roller 14 in order to press it on the rail 4.

FIGS. 9 and 10 also show that, in this embodiment, the guide roller 14 can be secured with the housing 17 or pressure piece thereof to the chassis axle 2 without any tools and can also be removed therefrom again. In the embodiment specifically shown, this is achieved by the housing 17 being retained between securing brackets 18 and a support 19 of the chassis axle 2 and thus being able to be removed at any time from the chassis axle 2 and replaced by another guide roller 14 with the housing 17 thereof, where applicable with a stronger or weaker pretensioning apparatus 15.

Finally, it should further be noted that, in this embodiment, the chassis axle 2 preferably comprises at least for the most part a plastics material, in a particularly preferred manner a fiber-reinforced plastics material. The chassis axle can thereby be constructed in a very light but nonetheless very stable manner, whereby the inertia forces which have to be overcome during acceleration and braking of the transport vehicle are reduced. Furthermore, such chassis axles of plastics material or fiber-reinforced plastics material can be produced in a relatively inexpensive manner.

### LEGEND OF THE REFERENCE NUMERALS

1 Chassis
2 Chassis axle
3 Roller
4 Rail
5 Pivot arm
6 Roller rotation axis
7 Pivot joint
8 Support bearing
9 Pivot axis
10 Support direction
11 Sliding surface
12 Sliding surface
13 Surface normal
14 Guide roller
15 Pretensioning apparatus
16 Vibration damper
17 Housing
18 Securing bracket
19 Support
20 Ball bearing
21 Guide roller rotation axis
22 Plain pivot bearing
23 Surface
24 Surface
25 Roller carrier
26 Pretensioning spring
27 Damping piston
28 Plate
29 Seal
30 Throttle opening
31 Damper housing
32 Delimiting projections
33 Connection
34 Longitudinal direction
35 Guide channel

1. A chassis for a rail-bound transport vehicle for transporting goods, the chassis comprising:
at least one chassis axle;
at least one load-bearing roller configured for rolling on a rail;
the at least one roller being rotatably supported on a pivot arm about a roller rotation axis, and the pivot arm together with the roller is pivotably supported by a pivot joint on the chassis axle; and
a support bearing that supports the pivot arm on the chassis axle, and the at least one roller is arranged between the pivot joint and the support bearing.

2. The chassis as claimed in claim 1, wherein a pivot axis of the pivot joint, about which axis the pivot arm is pivotable, is arranged parallel with a support direction, and the pivot arm is supported on the chassis axle by the support bearing in the support direction.

3. The chassis as claimed in claim 2, wherein the support bearing is a plain bearing which permits a pivoting of the pivot arm via the pivot joint.

4. The chassis as claimed in claim 3, wherein the plain bearing has two sliding surfaces which slide along each other when the pivot arm is pivoted.

5. The chassis as claimed in claim 4, wherein one of the sliding surfaces comprises metal, and an other of the sliding surfaces comprises a plastic material.

6. The chassis as claimed in claim 4, wherein the sliding surfaces are at least partially constructed with planar regions and a surface normal on the planar region of one of the sliding surfaces is arranged parallel with the pivot axis of the pivot joint, about which axis the pivot arm is pivotable.

7. The chassis as claimed in claim 2, wherein the roller rotation axis is arranged orthogonally relative to the pivot axis of the pivot joint, about which axis the pivot arm is pivotable.

8. The chassis as claimed in claim 1, further comprising at least one guide roller arranged on the chassis axle and which is resiliently pretensioned by a pretensioning apparatus in a direction toward the rail.

9. The chassis as claimed in claim 8, further comprising a vibration damper integrated in the pretensioning apparatus.

10. The chassis as claimed in claim 8, wherein the pretensioning apparatus is configured to be securable to and removable from the chassis axle without any tools.

11. The chassis as claimed in claim 1, wherein a majority of the chassis axle is comprised of a plastic material.

12. The chassis as claimed in claim 11, wherein the plastic material a fiber-reinforced plastic material.
